(19) United States
(12) Patent Application Publication
(10) Pub. No.: US 2026/0087070 A1
(43) Pub. Date: Mar. 26, 2026

(54) METHOD, COMPUTER DEVICE, AND COMPUTER-READABLE RECORDING MEDIUM TO PROVIDE MESSAGE SUMMARY AND ASSOCIATED IMAGE

(71) Applicant: LINE Plus Corporation, Seongnam-si (KR)

(72) Inventors: Soon Hyun KWON, Seongnam-si (KR); Joo Hong LEE, Seongnam-si (KR); Chul Hwan YUN, Seongnam-si (KR); Ji Su HO, Seongnam-si (KR)

(73) Assignee: LINE Plus Corporation, Seongnam-si (KR)

(21) Appl. No.: 19/337,025

(22) Filed: Sep. 23, 2025

(30) Foreign Application Priority Data
Sep. 24, 2024 (KR) 10-2024-0128908

(51) Int. Cl. G06F 16/538; G06F 16/34; G06F 16/535; G06F 16/55

(52) U.S. Cl. CPC G06F 16/538; G06F 16/345; G06F 16/535; G06F 16/55

(57) ABSTRACT

A method of providing a message summary and an associated image may include requesting an image search in relation to a message summary created based on a message in a chatroom; receiving an image bundle that includes at least one image in response to an image search request; and displaying the image bundle in association with the message summary.

### CROSS-REFERENCE TO RELATED APPLICATION(S)

This U.S. non-provisional application and claims the benefit of priority under 35 U.S.C. § 119 to Korean Patent Application No. 10-2024-0128908, filed Sep. 24, 2024, the entire contents of which are incorporated herein by reference in their entirety.

### BACKGROUND

### Technical Field

Some example embodiments relate to technology for providing a message summary of a chatroom.

### Related Art

An instant messenger, a common communication tool, is software that allows users to transmit and receive messages or data in real time, and allows a user to register conversation partners and to exchange messages in real time with a counterpart on a conversation partner list.

This messenger function is becoming popular not only on a personal computer (PC) but also in a mobile environment of a mobile communication terminal that, for example, uses a wireless communication network that enables a messenger service to be provided between mobile messengers installed on portable terminals.

The use of the instant messenger is becoming popular and functions provided through the instant messenger are becoming more diverse. In particular, as the importance of personal information protection is emphasized, an openchat function is being provided, which allows chat using a link without sharing personal information such as a telephone number or an ID.

### SUMMARY

Some example embodiments may provide an image with a high relevance to a message summary when providing the message summary in which messages in a chatroom are summarized.

At least some example embodiments relate to a method of providing a message summary performed by a computer device. In some example embodiments, the computer device includes at least one processor configured to execute computer-readable instructions included in a memory.

In some example embodiments, the method includes requesting, by the at least one processor, an image search in relation to the message summary created based on a message in a chatroom; receiving, by the at least one processor, an image bundle that includes at least one image, in response to requesting the image search; and displaying, by the at least one processor, the image bundle in association with the message summary.

In some example embodiments, the method includes creating the message summary using a message of a text type as the message to be summarized among messages exchanged after a previous message summary in the chatroom.

In some example embodiments, the creating the message summary includes reordering the message to be summarized based on a relationship between messages prior to creating the message summary.

In some example embodiments, the creating the message summary further comprises creating the message summary using meta information of the chatroom with the message to be summarized, the meta information including at least one of a title, a description, a topic, and a category of the chatroom.

In some example embodiments, the image bundle includes images related to the message summary among messages exchanged after a previous message summary in the chatroom.

In some example embodiments, the image bundle includes a number of images in a descending order of a similarity score between the images and the message summary among images exchanged after a previous message summary in the chatroom.

In some example embodiments, the image bundle includes images of which the similarity score with the message summary is greater than or equal to a threshold.

In some example embodiments, if the number of images of which the similarity score with the message summary is greater than or equal to a threshold is less than a set number, at least one additional image from an external server is added to the image bundle.

In some example embodiments, the image bundle includes images related to the message summary among images on an external server.

In some example embodiments, the displaying includes sorting images included in the image bundle based on their similarity score with the message summary.

In some example embodiments, the displaying includes displaying the message summary and a main keyword representing the message summary together with the image bundle.

According to at least one example embodiment, there is provided a non-transitory computer-readable recording medium to execute the message summary providing method on the computer device.

According to at least one example embodiment, there is provided a computer device including at least one processor configured to execute computer-readable instructions included in a memory to configure the computer device to request an image search in relation to a message summary created based on a message in a chatroom, receive an image bundle that includes at least one image, in response to the request for the image search, and display the image bundle in association with the message summary.

Further areas of applicability will become apparent from the description provided herein. The description and specific examples in this summary are intended for purposes of illustration only and are not intended to limit the scope of the present disclosure.

### BRIEF DESCRIPTION OF DRAWINGS

FIG. 1 is a diagram illustrating an example of a network environment according to at least one example embodiment;

FIG. 2 is a diagram illustrating an example of a computer device according to at least one example embodiment;

FIG. 3 is a flowchart illustrating an example of a method capable of being performed by a computer device according to at least one example embodiment;

FIG. 4 illustrates an example of a process of determining whether to create a message summary of a chatroom in at least one example embodiment;

FIG. 5 illustrates an example of a message summary creation process in at least one example embodiment;

FIG. 6 illustrates an example of an image search process in at least one example embodiment;

FIGS. 7 to 9 illustrate an example of a message summary providing process in at least one example embodiment; and

FIGS. 10 and 11 illustrate an example of utilizing a message summary in at least one example embodiment.

### DETAILED DESCRIPTION

One or more example embodiments will be described in detail with reference to the accompanying drawings. Example embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated.

As used herein, the singular forms “a,” “an,” and “the,” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups, thereof. As used herein, the term “and/or” includes any and all combinations of one or more of the associated listed products. Expressions such as “at least one of,” when preceding a list of elements, modify the entire list of elements and do not modify the individual elements of the list. Also, the term “exemplary” is intended to refer to an example or illustration.

Unless otherwise defined, all terms (including technical and scientific terms) used herein have the same meaning as commonly understood by one of ordinary skill in the art to which example embodiments belong. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as one computer processing device; however, one skilled in the art will appreciate that a hardware device may include multiple processing elements and multiple types of processing elements. For example, a hardware device may include multiple processors or a processor and a controller. In addition, other processing configurations are possible, such as parallel processors.

Hereinafter, some example embodiments will be described with reference to the accompanying drawings.

At least some example embodiments relate to technology for providing a message summary of a chatroom.

At least some example embodiments may provide an image capable of explaining a message summary when summarizing messages in a chatroom and then providing the message summary.

A message summary providing system according to some example embodiments may be implemented by at least one computer device, and a message summary providing method according to some example embodiments may be performed through the at least one computer device included in the message summary providing system. Here, a computer program according to an example embodiment may be installed and run on the computer device, and the computer device may perform the message summary providing method according to example embodiments under control of the computer program. The aforementioned computer program may be stored in a non-transitory computer-readable record medium to implement the message summary providing method in conjunction with the computer device.

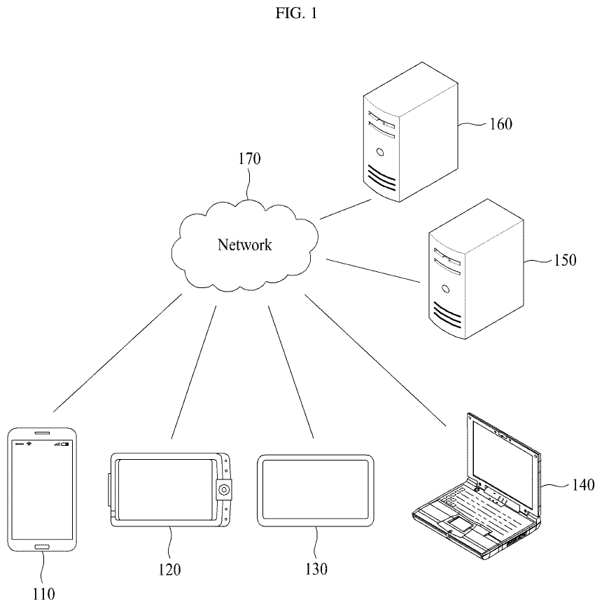

FIG. 1 illustrates an example of a network environment according to at least one example embodiment.

Referring to FIG. 1, the network environment may include a plurality of electronic devices 110, 120, 130, and 140, a plurality of servers 150 and 160, and a network 170. The network environment illustrated in FIG. 1 is provided as an example only and an environment applicable to the example embodiments is not limited to the network environment of FIG. 1. For example, the number of electronic devices or the number of servers is not limited thereto.

Each of the plurality of electronic devices 110, 120, 130, and 140 may be a fixed terminal or a mobile terminal that is configured as a computer device. For example, the plurality of electronic devices 110, 120, 130, and 140 may be a smartphone, a mobile phone, a navigation device, a computer, a laptop computer, a digital broadcasting terminal, a personal digital assistant (PDA), a portable multimedia player (PMP), a tablet PC, and the like. For example, although FIG. 1 illustrates a shape of a smartphone as an example of the electronic device 110, the electronic device 110 used herein may refer to one of various types of physical computer devices capable of communicating with other electronic devices 120, 130, and 140, and/or the servers 150 and 160 over the network 170 in a wireless and/or wired communication manner.

The communication scheme is not limited, and may include a near field wireless communication scheme between devices as well as a communication scheme using a communication network (e.g., a mobile communication network, wired Internet, wireless Internet, and/or a broadcasting network) includable in the network 170. For example, the network 170 may include at least one of network topologies that include a personal area network (PAN), a local area network (LAN), a campus area network (CAN), a metropolitan area network (MAN), a wide area network (WAN), a broadband network (BBN), and the Internet. Also, the network 170 may include at least one of network topologies that include a bus network, a star network, a ring network, a mesh network, a star-bus network, a tree or hierarchical network, and the like. However, these networks are provided as examples only.

Each of the servers 150 and 160 may be implemented as a computer device or a plurality of computer devices that provides an instruction, a code, a file, content, a service, etc., through communication with the plurality of electronic devices 110, 120, 130, and 140 over the network 170. For example, the server 150 may be a system that provides a service (e.g., a messenger service) to the plurality of electronic devices 110, 120, 130, and 140 connected over the network 170.

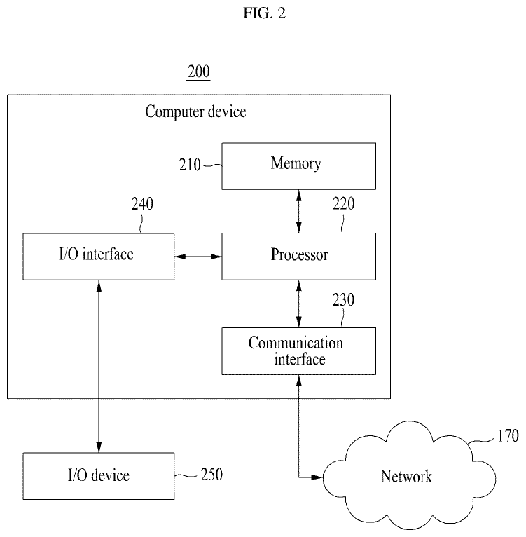

FIG. 2 is a block diagram illustrating an example of a computer device according to at least one example embodiment. Each of the plurality of electronic devices 110, 120, 130, and 140 or each of the servers 150 and 160 may be implemented by a computer device 200 of FIG. 2.

Referring to FIG. 2, the computer device 200 may include a memory 210, a processor 220, a communication interface 230, and an input/output (I/O) interface 240.

The memory 210 may include a permanent mass storage device, such as a random access memory (RAM), a read only memory (ROM), and a disk drive, as a non-transitory computer-readable record medium. The permanent mass storage device, such as ROM and a disk drive, may be included in the computer device 200 as a permanent storage device separate from the memory 210. Also, an operating system (OS) and at least one program code may be stored in the memory 210. Such software components may be loaded to the memory 210 from another non-transitory computer-readable record medium separate from the memory 210. The other non-transitory computer-readable record medium may include a non-transitory computer-readable record medium, for example, a floppy drive, a disk, a tape, a DVD/CD-ROM drive, a memory card, etc. According to other example embodiments, software components may be loaded to the memory 210 through the communication interface 230, instead of the non-transitory computer-readable record medium. For example, the software components may be loaded to the memory 210 of the computer device 200 based on a computer program installed by files received over the network 170.

The processor 220 may be configured to process instructions of a computer program by performing basic arithmetic operations, logic operations, and I/O operations. The computer-readable instructions may be provided to the processor 220 through the memory 210 or the communication interface 230. For example, the processor 220 may be configured to execute received instructions in response to a program code stored in a storage device, such as the memory 210.

The communication interface 230 may provide a function for communication between the computer device 200 and another apparatus, for example, the aforementioned storage devices, over the network 170. For example, the processor 220 of the computer device 200 may forward a request or an instruction created based on a program code stored in the storage device such as the memory 210, data, and a file, to other apparatuses over the network 170 under control of the communication interface 230. Inversely, a signal, an instruction, data, a file, etc., from another apparatus may be received at the computer device 200 through the communication interface 230 of the computer device 200. A signal, an instruction, data, etc., received through the communication interface 230 may be forwarded to the processor 220 or the memory 210, and a file, etc., may be stored in a storage medium, for example, the permanent storage device, further includable in the computer device 200.

The I/O interface 240 may be a device used for interfacing with an I/O device 250. For example, an input device may include a device, such as a microphone, a keyboard, a mouse, etc., and an output device may include a device, such as a display, a speaker, etc. As another example, the I/O interface 240 may be a device for interfacing with an apparatus in which an input function and an output function are integrated into a single function, such as a touchscreen. The I/O device 250 may be configured as a single apparatus with the computer device 200.

Also, according to other example embodiments, the computer device 200 may include a greater or smaller number of components than the number of components shown in FIG. 2. However, there is no need to clearly illustrate such components as one skilled in the art would readily appreciate such components. For example, the computer device 200 may be configured to include at least a portion of the I/O device 250 or may further include other components, such as a transceiver and a database.

Hereinafter, at least some example embodiments of a method and device for providing a message summary and an associated image are described.

The following example embodiments describe an instant messenger as a representative example, but any social platform that provides various types of services utilizing resources, such as user profile information and friend relationship within a social network service, as well as the social network service such as various types of communities may be applied in addition to the messenger.

In this specification, openchat refers to a chat service that allows conversation between users on topics of interest and also represents a community service that allows a chat using a link, such as a universal resource locator (URL), without a friend addition process using a telephone number or an ID. A function that allows the messenger to automatically run such that a chatroom (or, alternatively, a channel) corresponding to an openchat link is executed may be included to enable a chat to immediately start in response to a click on the openchat link.

At least some example embodiments may be directed to a method and/or computer device that may summarize messages created in an openchat chatroom through an artificial intelligence (AI) solution and, here, may show a message summary for a user having unread messages accumulated in the corresponding chatroom.

In particular, at least some example embodiments may provide an image with a high relevance to a message summary together with the message summary, when providing the message summary in an openchat chatroom.

The following example embodiment describes openchat as a representative example, but example embodiments are not limited thereto, and may be applied to not only a one-to-one chatroom based on relationship information but also any chatrooms associated with an instant messenger, such as a group chatroom and an official account chatroom, in addition to openchat.

The computer device 200 according to the example embodiment may provide a client with a messenger service through connection to a dedicated application installed on the client or a website/mobile site related to the computer device 200. A computer-implemented message summary providing system may be configured in the computer device 200. For example, the message summary providing system may be implemented in the form of an independently operating program, or may be configured in an in-app form of a specific operation to be operable on the specific application.

The processor 220 of the computer device 200 may be implemented as a component for performing the following message summary providing method. Depending on example embodiments, components of the processor 220 may be selectively included in or excluded from the processor 220. Also, components of the processor 220 may be separated or merged for expressions of functions of the processor 220 depending on example embodiments.

This processor 220 and the components of the processor 220 may control the computer device 200 to perform operations included in the following message summary providing method. For example, the processor 220 and the components of the processor 220 may be implemented to execute an instruction according to a code of at least one program and a code of an operating system (OS) included in the memory 210.

Here, the components of the processor 220 may be representations of different functions performed by the processor 220 in response to an instruction provided from a program code stored in the computer device 200.

The processor 220 may read a necessary instruction from the memory 210 to which instructions related to control of the computer device 200 are loaded. In this case, the read instruction may include an instruction for controlling the processor 220 to execute operations to be described below.

Operations in the message summary providing method described below may be performed in order different from the illustrated order, and some of the operations may be omitted or an additional process may be further included.

Operations included in the message summary providing method may be performed by the client and, depending on example embodiments, at least some of the operations may also be performed by the server 150.

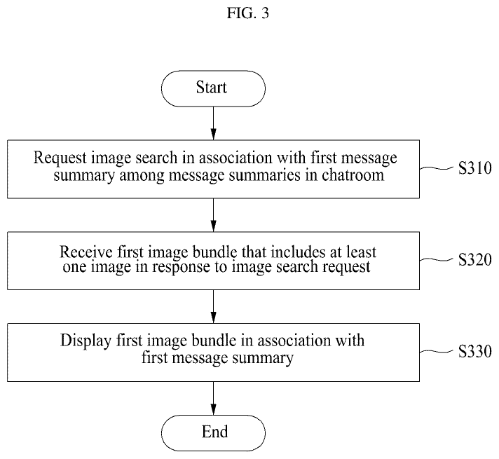

FIG. 3 is a flowchart illustrating an example of a method capable of being performed by a computer device according to at least one example embodiment.

Referring to FIG. 3, in operation S310, the processor 220 may request an image search in association with a recently created message summary (hereinafter, referred to as a ‘first message summary’) among message summaries in a chatroom.

The processor 220 may determine whether to create a message summary in an openchat chatroom using a desired (or, alternatively, a predetermined) message summary creation condition. For example, the message summary creation condition may include a condition on the number of messages exchanged through the chatroom. For example, if the number of messages created in the chatroom up to a current point in time after a previous message summary is greater than or equal to a threshold, the corresponding chatroom may be determined as a chatroom that requires a message summary, that is, a chatroom subject to message summary. Here, the message summary creation condition may be set as a common fixed condition for all openchat chatrooms. A threshold for a message summary target condition and a cycle (or time) for determining whether to create a message summary may be applied to all chatrooms. For example, the number of messages may be verified at set time intervals for the entire chatrooms and a chatroom with the number of messages greater than or equal to the threshold may be classified as a chatroom subject to message summary. Depending on example embodiments, the threshold for the message summary target condition and the cycle (or time) for determining whether to create a message summary may be set for each chatroom in consideration of characteristics of a corresponding chatroom. The processor 220 may analyze message traffic per unit time for each openchat chatroom and may set the threshold for the message summary target condition and the cycle for determining whether to create a message summary based on analysis results. For example, the threshold may be set higher such that a chatroom with a high message creation volume may have a shorter creation cycle, and if a set condition is satisfied at a cycle set for a corresponding chatroom for each chatroom, the chatroom may be determined to require a message summary.

In the case of a chatroom that satisfies the message summary creation condition, the processor 220 may create the message summary using at least some of messages included in the chatroom. The processor 220 may create the message summary by calling a message summary interface linked to the server 150 or the other server 160. For example, the processor 220 may create the message summary through an AI solution using a language model by calling a language model (e.g., generative pretrained transformer (GPT)) API for message summary. Here, the processor 220 may select and summarize a message corresponding to a text type as a message to be summarized among messages created in the chatroom up to a current point in time after a previous message summary. Depending on example embodiments, a message to be summarized may be summarized using meta information of the chatroom. Here, the meta information may include at least one of a title, a description, a topic, and a category of the chatroom.

The processor 220 may transmit an image search request to the server 150 in association with the message summary, that is, the first message summary created at the corresponding cycle every message summary creation cycle.

In operation S320, in response to the image search request in operation S310, the processor 220 may receive, from the server 150, a first image bundle that includes at least one image related to the first message summary.

Among messages created in the chatroom during a time section from the previous message summary to the current point in time according to the message summary creation cycle, a message corresponding to a text type may be a message to be summarized for creating the first message summary. Here, among the messages created in the chatroom during the time section, a message corresponding to an image type may be an image search target for the first message summary. That is, the processor 220 may search images within the chatroom and, here, may find an image related to the first message summary among images actually exchanged in the chatroom during the time section corresponding to the first message summary.

Depending on example embodiments, the processor 220 may search for an image related to the first message summary from among images on an external server (e.g., server 160) accessible from the server 150. For example, if the number of images related to the first message summary among images in the chatroom is less than the desired (or, alternatively the predetermined) number, an insufficient number of images may be retrieved from the external server.

In operation S330, the processor 220 may display the message summary of the chatroom upon user request in the openchat chatroom. Here, the processor 220 may also display an image bundle related to each corresponding message summary for each message summary. The processor 220 may display the first image bundle in association with the first message summary when displaying the first message summary for the openchat chatroom. If there is no image highly relevant to the message summary based on image search results, only the message summary may be displayed without an associated image bundle.

The processor 220 may acquire an image bundle related to the message summary through an image search within the chatroom at each point in time at which the message summary is created for each time section of the chatroom.

The described method addresses technical challenges inherent in conventional chatroom interfaces, where the rapid accumulation of text-based messages and corresponding images exchanged between users can overwhelm computational resources and user cognition, leading to inefficient data processing, increased latency in message retrieval, and higher bandwidth consumption as users scroll through voluminous content to extract key information. In one or more example embodiments, the processor 220 may implement a dual approach to enhance system performance in resource-constrained environments, such as mobile device, by creating a message summary to summarize unread messages in the chatroom and also requesting and integrating one or more relevant images into the generated message summary, thus enabling the creation and display of a visually enriched summary bundle that condenses complex conversational data into a more meaningful format, thereby enhancing the computer's graphical user interface functionality for faster comprehension and reduced processing demands. This integration of text summarization and image bundling not only optimizes memory usage by associating relevant visual data without requiring full message reloading but also improves overall system performance in bandwidth-constrained environments, such as mobile devices, by minimizing the need for repeated text parsing and enabling quicker, more intuitive user interactions that transform abstract message data into a practically applied, technology-driven communication tool. Further, by leveraging artificial intelligence (AI) to summarize accumulated unread messages, the system streamlines the user experience by reducing the need for repeated text parsing and also enabling quicker, more intuitive interactions, which minimize latency and enhance accessible across diverse device platforms. This approach integrates the summarization process into a practical application that specifically improves computer functionality in resource-constrained environments, such as mobile devices, by optimizing data processing demands and transforming voluminous, abstract conversational data into condensed, actionable bundles without requiring excessive reloading or computational overhead. Moreover, this dual approach provides significantly more than conventional summarization techniques, as it addresses particular technological challenges like bandwidth limitations and cognitive overload, thereby offering a non-routine enhancement to graphical user interfaces that ensures efficient, real-time communication in high-volume chat scenarios.

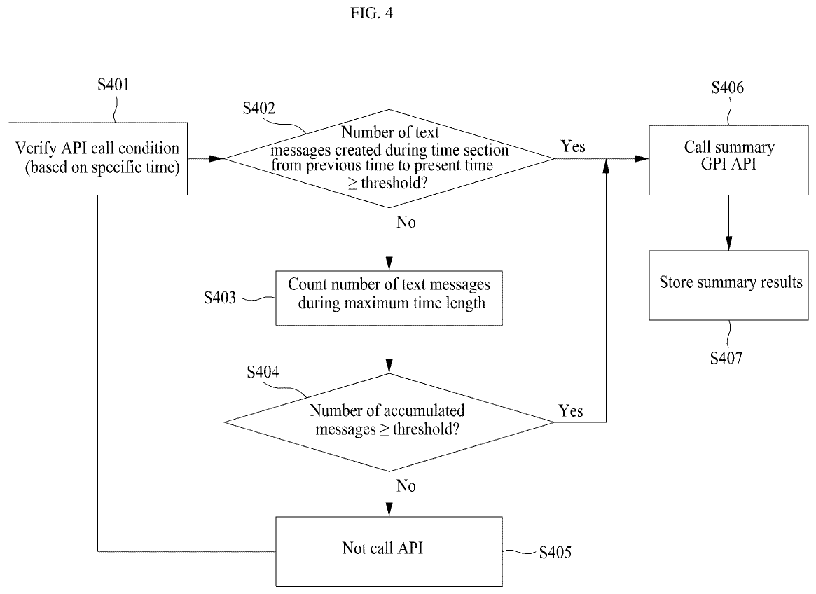

FIG. 4 illustrates an example of a process of determining whether to create a message summary of a chatroom in at least one example embodiment.

Referring to FIG. 4, in operation S401, the processor 220 may verify an API call condition that represents a message summary creation condition. The API call condition may include a cycle (or time) for determining whether to create a message summary and a threshold for a message summary target condition, which may be commonly set for all chatrooms or may be differently set for each chatroom.

In operation S402, the processor 220 may determine whether the number of messages of a text type created in the chatroom during a time section from a previous message summary to a current point in time is greater than or equal to the threshold according to the API call condition.

In operation S403, if the number of text messages in the chatroom after the previous message summary is less than the threshold, the processor 220 may count the number of text images during a maximum time length.

In operation S404, the processor 220 may determine whether the number of text messages counted during the maximum time length is greater than or equal to the threshold that is the message summary target condition.

In operation S405, if the number of text messages counted during the maximum time length is less than the threshold, the processor 220 may determine that the message summary creation condition is not satisfied and may not call a message summary interface.

In operation S406, if the number of text messages accumulated in the chatroom during the time section from the previous message summary to the current point in time is greater than or equal to the threshold, the processor 220 may call a language model API for message summary as the message summary interface and may create the message summary.

In operation S407, the processor 220 may store and manage the message summary created through an AI solution using a language model in association with the corresponding chatroom.

The above process (operations S401 to S407) may be repeated for each chatroom at each set cycle (or time), and if the chatroom satisfies the message summary creation condition, the message summary may be created.

According to the example embodiment, rather than performing a message summary upon user request for each individual client, a single common message summary may be created and then, stored and managed for each chatroom on the server 150.

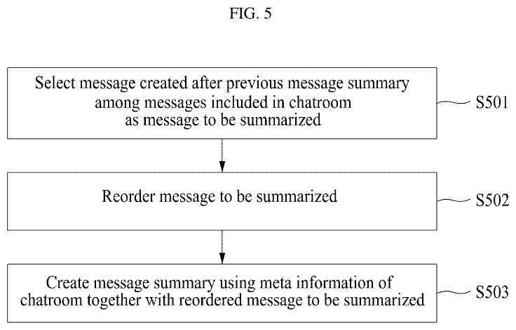

FIG. 5 illustrates an example of a message summary creation process in at least one example embodiment.

The processor 220 may create a message summary for each chatroom that satisfies a message summary creation condition.

Referring to FIG. 5, in operation S501, the processor 220 may select a message of a text type created in a chatroom during a time section from a previous message summary to a current point in time among messages included in the chatroom as a message to be summarized.

If there is a previous message summary history in the chatroom, the processor 220 may select a text message exchanged through the chatroom after the previous summary message as the message to be summarized.

In operation S502, the processor 220 may reorder the message to be summarized based on relationship between messages.

For example, in the case of a message created using a reply or mention function among messages to be summarized, the processor 220 may change the message order of the message as a message that comes next in the order of a related message. For example, if a message summary is created without reordering a message A and a reply message in a situation in which a considerable amount of time has elapsed after transmitting the message A and reply of the message A is received after messages on various topics are transmitted and received, summary performance may be degraded. To improve the summary performance, the processor 220 may reorder the reply to the message A to be a message that immediately follows the message A.

In operation S503, the processor 220 may create the message summary using meta information of the chatroom together with the reordered message to be summarized. The meta information may include at least one of a title of the chatroom, a description of the chatroom created by at least one of a chatroom administrator and a participant, a topic of the chatroom analyzed by the processor 220, and a category of the chatroom created by the chatroom administrator or the participant or analyzed by the processor 220. The processor 220 may reflect meta information of the chatroom as content boundary for the message summary of the chatroom.

The processor 220 may create the message summary by summarizing the message to be summarized using a large language model or a document summary model. Here, the large language model may refer to a language model that may perform inference without fine-tuning, using a method such as few-shot learning, and may have more than 10 times as many parameters (e.g., more than 110 billion parameters) as a conventional language model. For example, the large language model, such as GPT-3 and HyperClova, may be utilized as few-shot learners that may be controlled through a natural text prompt, and may perform in-context learning capable of solving natural language processing (NLP) issues by understanding patterns with only a small amount of data through the prompt. In addition to a few-shot learning method, a zero-shot learning method controllable through a directive without a prompt example and a fine-tuning-based learning method may be employed to summarize a message. The document summary model may refer to a learning model that automatically summarizes a message to be summarized into at least one keyword using NLP technology by verifying structural characteristics of a document and structuring the same according to certain rules and then extracting frequently occurring patterns from structured paragraphs of the document. The processor 220 may create a message summary in which a message to be summarized of each chatroom is summarized into at least one keyword for each chatroom using a language-based learning model, such as the large language model or the document summary model.

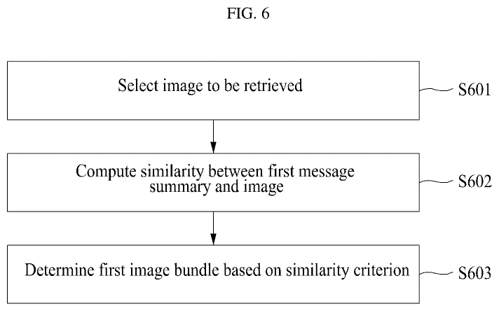

FIG. 6 illustrates an example of an image search process in at least one example embodiment. The image search process may be performed by the server 150, and, depending on example embodiments, at least some of operations may also be performed by a client.

Referring to FIG. 6, in operation S601, the server 150 may select an image to be retrieved from among images in the chatroom. The server 150 may select a message corresponding to an image type among messages created in the chatroom during a time section from a previous message summary to a current point in time as a time section in which a first message summary is created, as an image search target for the first message summary.

In operation S602, the server 150 may compute similarity score between each image selected as a search target and the first message summary. For example, the server 150 may convert the image to be retrieved to text (hereinafter, referred to as ‘image text’), may vectorize the first message summary and the image text, and may compute cosine similarity between the first message summary and the image text.

In operation S603, the server 150 may determine a first image bundle that includes at least one image based on the similarity score with the first message summary for the first message summary. The server 150 may configure a desired (or, alternatively, a predetermined) number of (e.g., top 5) images determined in descending order of the similarity score based on the similarity score with the first message summary among images selected as search target, as the first image bundle.

In the case of configuring the first image bundle by selecting images only with high score, an image that is not associated with the first message summary may be included. Therefore, to ensure a certain degree of relevance to the first message summary, an image for constituting the first image bundle may be limited to an image of which similarity score with the first message summary is greater than or equal to a threshold. That is, the server 150 may configure, as the first image bundle, the desired (or, alternatively, the predetermined) number of images with high similarity score among the images of which similarity score with the first message summary is greater than or equal to the threshold.

Some example embodiments describe an image in a chatroom as a search target, but example embodiments are not limited thereto, and may also search an external server for an image highly related to the first message summary. The server 150 may configure, as the first image bundle, the desired (or, alternatively, the predetermined) number of (e.g., 5) images with high similarity score with the first message summary among images on an accessible external server.

Depending on example embodiments, the first image bundle may be configured using images within the chatroom, but if the number of images of which similarity score with the first message summary is greater than or equal to the threshold is less than a desired (or, alternatively, a predetermined) number, the insufficient number of images may be retrieved from the external server and the desired (or, alternatively, the predetermined) number of images may be filled to configure the first image bundle. That is, the server 150 may create the first image bundle with high relevance to the first message summary by using an image set in the chatroom and an external image set as search target.

The message summary is created by time section according to a set cycle (or time), and a single message summary may include at least one topic. At least one bullet that indicates each sentence unit may be gathered to form a single topic. That is, the message summary may include at least one bullet.

In the case of receiving the first message summary upon image search request, the server 150 may compute the similarity score with image text with respect to text corresponding to the entire bullets that constitute the first message summary and may construct the first image bundle with high relevance to the first message summary.

Depending on example embodiments, it is possible to search for an image having high relevance to a corresponding bullet for each of bullets that constitute the first message summary and to provide image search results (image bundle) for each bullet using images related to the first message summary.

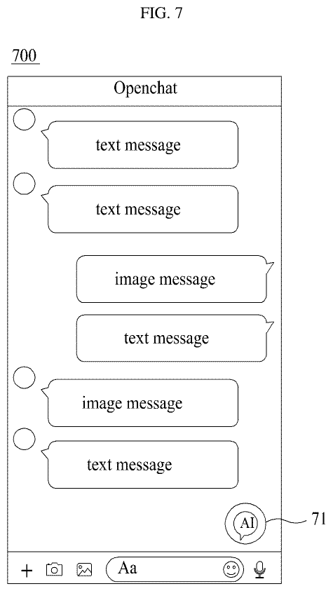

FIGS. 7 to 9 illustrate an example of a message summary providing process in at least one example embodiment.

Referring to FIG. 7, upon user entry request, the processor 220 may display a user interface (UI) 71 for accessing a message summary on a chatroom screen 700 at a time of entering the chatroom screen 700.

For example, when the user entry request to the chatroom is received, the processor 220 may identify a message read status of a user in the chatroom. The processor 220 may verify whether the number of unread messages in the chatroom is greater than or equal to a desired (or, alternatively, a predetermined) number (N) and whether a desired (or, alternatively, a predetermined) amount of time (M) has elapsed after last visit to the chatroom, as the message read status of the user. When a condition that the number of unread messages in the chatroom at a time of entering the chatroom screen 700 upon user entry request is greater than or equal to the number N and a condition that the last visit time has elapsed the amount of time M both are satisfied, the processor 220 may display the UI 71 for accessing the message summary on the chatroom screen 700.

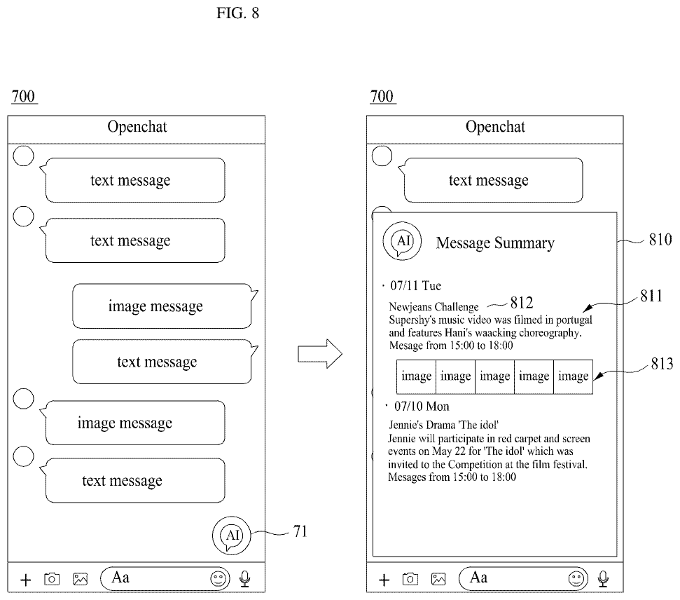

Referring to FIG. 8, when the user enters the chatroom screen 700 and selects the message summary UI 71, the processor 220 may provide a message summary page 810.

The processor 220 may provide the message summary page 810 that displays a message summary in which a message within a corresponding time section is summarized in a simple bullet for each time section according to a set cycle (or time), and may include summary content 811 that summarizes a message to be summarized, a main keyword 812 that represents the summary content 811, and an image bundle 813 with high relevance to the summary content 811.

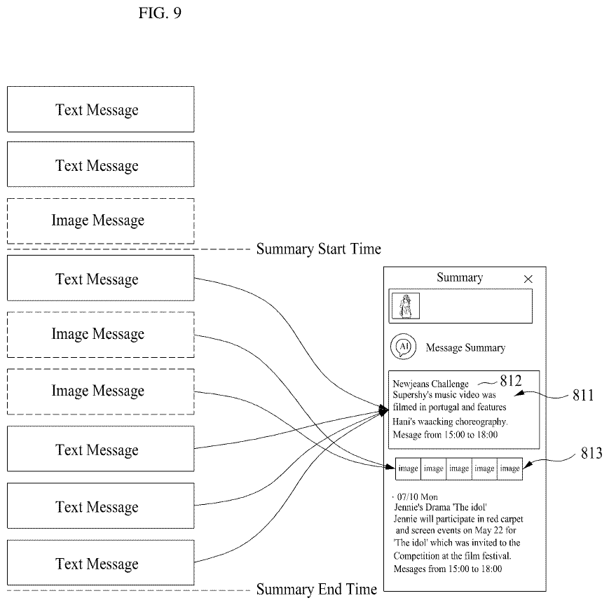

Referring to FIG. 9, the processor 220 may display the summary content 811 that summarizes text type messages among chatroom messages created between a summary start time and a summary end time of a set time section and the image bundle 813 according to image search results for image type messages, together.

The processor 220 may extract the main keyword 812 of the message summary by applying known technologies for extracting a most important word from a document based on importance of words, such as term frequency-inverse document frequency (TF-IDF) and Text-rank.

The server 150 according to some example embodiments may search for images related to a corresponding message summary for each message summary and may display the image bundle 813 configured as image search results in association with the summary content 811.

Images included in the image bundle 813 may be sorted in descending order of similarity score with the summary content 811. In addition to a similarity criterion, it is possible to sort the images included in the image bundle 813 in order of latest based on a message transmission and reception time or to randomly sort the images.

When the image bundle 813 is configured with images in the chatroom and images on an external server based on image search results, the images in the chatroom may be sorted by applying higher priority than the images on the external server.

Depending on example embodiments, when the summary content 811 includes at least two bullets, it is also possible to display an image with high relevance to a corresponding bullet in association with the bullet for each bullet.

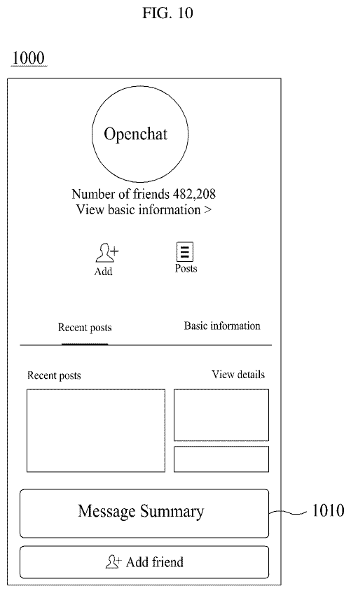

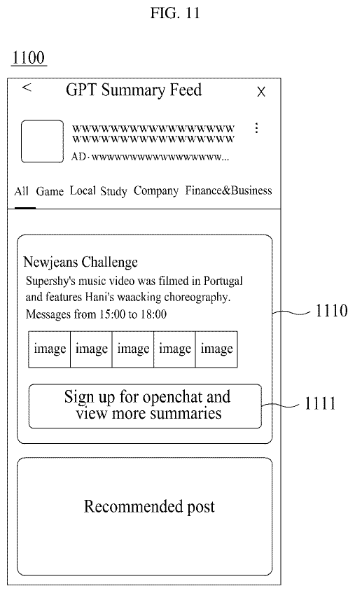

FIGS. 10 and 11 illustrate an example of utilizing a message summary in at least one example embodiment.

The processor 220 may utilize a message summary periodically created based on a chatroom, as content that introduces the chatroom. For example, referring to FIG. 10, the processor 220 may enter an openchat cover screen 1000 upon openchat cover entry request from the user, and here, may display at least one message summary 1010 through the openchat cover screen 1000. The openchat cover screen 1000 may represent a home screen (main screen) on which profile information (e.g., openchat name, profile image, openchat description, and number of signed-up members) on an openchat chatroom is displayed. The message summary 1010 displayed on the openchat cover screen 1000 may include, for example, a most recently created message summary, a message summary with the largest number of summarized messages, and a message summary with the largest number of conversation participants in the summarized messages. Here, an image bundle with high relevance to the message summary 1010 may be displayed on the openchat cover screen 1000 with the message summary 1010.

Further, at least some example embodiments may utilize a message summary periodically created based on a chatroom to provide a feed based on user personalization. The processor 220 may provide a message summary in which a main keyword matches a tag of interest set (or, alternatively, preset) by the user among message summaries created for each chatroom, as a personal recommendation feed for the user.

Referring to FIG. 11, the processor 220 may provide a feed provision page 1100 using a message summary to the user as one of service menus related to openchat. Here, the feed provision page 1100 may include a message summary 1110 that matches a tag preset by the user. The processor 220 may provide the message summary 1110 corresponding to the interest of the user as a feed and, here, may also provide an openchat link 1111 that may be directed to an openchat chatroom, a source of the corresponding message summary 1110, for each message summary 1110. In addition, when providing the message summary 1110 as a feed, it is possible to provide an image bundle with high relevance to the message summary 1110 in association with the message summary 1110 for each message summary 1110.

According to some example embodiments, when providing a message summary in which messages created in a chatroom are summarized, it is possible to provide an interface environment that may better explain the message summary intuitively by providing an image with a high relevance to the message summary.

The apparatuses described above may be implemented using hardware components, software components, and/or combination thereof. For example, the apparatuses and components described herein may be implemented using one or more general-purpose or special purpose computers, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. A processing device may run an operating system (OS) and one or more software applications that run on the OS. The processing device also may access, store, manipulate, process, and create data in response to execution of the software. For simplicity, the description of the processing device is used as singular; however, one skilled in the art will be appreciated that the processing device may include multiple processing elements and/or multiple types of processing elements. For example, the processing device may include multiple processors or a processor and a controller. In addition, different processing configurations are possible, such as parallel processors.

The software may include a computer program, a piece of code, an instruction, or some combinations thereof, for independently or collectively instructing or configuring the processing device to operate as desired. Software and/or data may be embodied in any type of machine, component, physical equipment, virtual equipment, a computer storage medium or device, or in a propagated signal wave capable of providing instructions or data to or being interpreted by the processing device. The software also may be distributed over network coupled computer devices so that the software is stored and executed in a distributed fashion. The software and data may be stored by one or more computer readable storage mediums.

The methods according to some example embodiments may be configured in a form of program instructions performed through various computer methods and recorded in non-transitory computer-readable media. Here, the media may continuously store computer-executable programs or may temporarily store the same for execution or download. Also, the media may be various types of recording devices or storage devices in a form in which one or a plurality of hardware components are combined. Without being limited to media directly connected to a computer system, the media may be distributed over the network. Examples of the media may include magnetic media such as hard disks, floppy disks, and magnetic tapes; optical media such as CD-ROM and DVDs; magneto-optical media such as floptical disks; and hardware devices that are specially configured to store and perform program instructions, such as ROM, RAM, flash memory, and the like. Examples of other media may include recording media and storage media managed by an app store that distributes applications or a site, a server, and the like that supplies and distributes other various types of software. Examples of the program instructions include an advanced language code that may be executed by a computer using an interpreter as well as a machine language code as produced by a compiler.

While this disclosure includes specific example embodiments, it will be apparent to one of ordinary skill in the art that various alterations and modifications in form and details may be made in these example embodiments without departing from the spirit and scope of the claims and their equivalents. For example, suitable results may be achieved if the described techniques are performed in a different order, and/or if components in a described system, architecture, device, or circuit are combined in a different manner, and/or replaced or supplemented by other components or their equivalents. Therefore, other implementations, other example embodiments, and equivalents are within the scope of the following claims.

What is claimed is:

1. A method of providing a message summary performed by a computer device, wherein the computer device includes at least one processor configured to execute computer-readable instructions included in a memory, the method comprising:
requesting, by the at least one processor, an image search in relation to the message summary created based on a message in a chatroom;
receiving, by the at least one processor, an image bundle that includes at least one image, in response to requesting the image search; and
displaying, by the at least one processor, the image bundle in association with the message summary.

2. The method of claim 1, further comprising:
creating the message summary using a message of a text type as the message to be summarized among messages exchanged after a previous message summary in the chatroom.

3. The method of claim 2, wherein the creating the message summary includes reordering the message to be summarized based on a relationship between messages prior to creating the message summary.

4. The method of claim 2, wherein the creating the message summary further comprises creating the message summary using meta information of the chatroom with the message to be summarized, the meta information including at least one of a title, a description, a topic, and a category of the chatroom.

5. The method of claim 1, wherein the image bundle includes images related to the message summary among messages exchanged after a previous message summary in the chatroom.

6. The method of claim 1, wherein the image bundle includes a number of images in a descending order of a similarity score between the images and the message summary among images exchanged after a previous message summary in the chatroom.

7. The method of claim 6, wherein the image bundle includes images of which the similarity score with the message summary is greater than or equal to a threshold.

8. The method of claim 6, wherein if the number of images of which the similarity score with the message summary is greater than or equal to a threshold is less than a set number, at least one additional image from an external server is added to the image bundle.

9. The method of claim 1, wherein the image bundle includes images related to the message summary among images on an external server.

10. The method of claim 1, wherein the displaying comprises:
sorting images included in the image bundle based on their similarity score with the message summary.

11. The method of claim 1, wherein the displaying comprises:
displaying the message summary and a main keyword representing the message summary together with the image bundle.

12. A non-transitory computer-readable recording medium to execute the method of claim 1 on the computer device.

13. A computer device comprising:
at least one processor configured to execute computer-readable instructions included in a memory to configure the computer device to,
request an image search in relation to a message summary created based on a message in a chatroom;
receive an image bundle that includes at least one image, in response to the request for the image search; and
display the image bundle in association with the message summary.

14. The computer device of claim 13, wherein the compute device is further configured to create the message summary using a message of a text type as the message to be summarized among messages exchanged after a previous message summary in the chatroom.

15. The computer device of claim 13, wherein the image bundle includes images related to the message summary among messages exchanged after a previous message summary in the chatroom.

16. The computer device of claim 13, wherein the image bundle includes a number of images in descending order of a similarity score between the images and the message summary among images exchanged after a previous message summary in the chatroom.

17. The computer device of claim 16, wherein the image bundle includes images of which the similarity score with the message summary is greater than or equal to a threshold.

18. The computer device of claim 16, wherein the image bundle includes images of which the similarity score with the message summary is greater than or equal to a threshold, and
if the number of images of which the similarity score with the message summary is greater than or equal to the threshold is less than a set number, at least one additional image from an external server is added to the image bundle.

19. The computer device of claim 13, wherein the image bundle includes images related to the message summary among images on an external server.

20. The computer device of claim 13, wherein the at least one processor is configured to sort images included in the image bundle based on their similarity score with the message summary.
